(19) United States
(12) Patent Application Publication
(10) Pub. No.: US 2016/0367896 A1
(43) Pub. Date: Dec. 22, 2016

(54) METHOD FOR PROVIDING TREASURE HUNTING SERVICE AND SYSTEM THEREFOR

(71) Applicants: Young Taek LEE, Seoul (KR); Hyun Bin LEE, Seoul (KR)

(72) Inventors: Young Taek LEE, Seoul (KR); Hyun Bin LEE, Seoul (KR)

(21) Appl. No.: 15/108,565

(22) PCT Filed: Dec. 4, 2014
(86) PCT No.: PCT/KR2014/011836

§ 371 Date: Jul. 9, 2016

(30) Foreign Application Priority Data
Dec. 30, 2013 (KR) 10-2013-0167304

(51) Int. Cl. A63F 13/35; A63F 13/79; A63F 13/216; A63F 13/335; A63F 13/847

(52) U.S. Cl. CPC A63F 13/35; A63F 13/335; A63F 13/847; A63F 13/216; A63F 13/79; A63F 2300/407; A63F 2300/8082; A63F 2300/8094

(57) ABSTRACT

The present invention relates to a method for providing a treasure hunting service and a system therefor and, particularly, to a method for providing a treasure hunting service and system therefor whereby virtual and real environments are continuously linked to each other since a location of treasure and multi-stage tasks to find the locations are provided in the virtual environment but most of the task executions thereof are carried out in the real environment, and thereby a game user leaves the screen. Thus, the virtual and real environments are seamlessly connected to each other and moved in a cycle. Limitations of the virtual environment can be overcome such that a result achieved in the real environment, which is an actual living space, is registered in the virtual environment and enables the game user to increase his grade. The game user can enjoy various qualifications and benefits according to the promotion.

### TECHNICAL FIELD

The present invention relates, generally, to a method for providing a treasure hunting service and a system therefor. More particularly, it relates to a method for providing a treasure hunting service in which a virtual world/real world interaction is performed by using wired and wireless communications, thereby, player enjoyment can be increased by providing activities in the real world.

### BACKGROUND ART

A treasure hunting game is a game played by people of all ages and sexes at picnics, meetings, etc. Papers with stamps or specific cards, goods, etc. are presented as treasures, and the treasures are hidden in a fixed space before the game begins. When the game begins, participants search for the treasures over a fixed time. The treasure hunting game provides an appointed premium or good, or an appointed value according to a level of the treasure or number of treasures that participants find.

In general, PCs or smart-phones, entertainment system such as Playstation, X-Box, etc. run programs or applications that are spatially limited to the device itself. When an identical game is played by multiple game users, the game user may increase his or her ranking by obtaining points and resources through an on-line connection with unspecified individuals within predetermined rules of the game program or by battling other game users. However, game play does not leave the screen.

Therefore, only a certain increase in level and items capable of performing particular transactions are obtained by those games. In such conventional game, a user achieves his or her individual target level and skill level, but these achievements do not lead to a value that can be shared by other game users. Such achievements are values that are confirmed in the virtual world and, except by professional gamers, it is difficult for a player to be credited for his or her achievement proportional to the amount of time spent playing the game.

### RELATED ART DOCUMENTS

(Patent Document 1) Korean Patent Application No. 10-2000-0010975 (Finding the treasure in the 3D Internet)

(Patent Document 2) Korean Patent Application No. 10-2002-0020056 (Game method for a treasure-hunting using wireless network)

### DISCLOSURE

### Technical Problem

Accordingly, the present invention has been made to overcome the above limitation of a game that is restricted to a virtual world, and the present invention is intended to propose a method for providing a treasure hunting service and a system therefor in which a treasure hunting service with a virtual/real world interaction through wired and wireless communications is provided and high satisfaction of the game user is realized by guaranteeing activities in a real environment.

However, technical subjects to be solved by the present invention are not restricted to the above-mentioned description, and any other technical problems not mentioned so far will be clearly appreciated from the following description by the skilled in the art.

### Technical Solution

In order to achieve the above object, according to one embodiment of the present invention, there is provided a method for providing a treasure hunting service, the service using an operating server and user terminals including a hider terminal and a hunter terminal, whereby a player finds a treasure hidden in a real environment via a virtual/real interaction, the method may include: a membership registration step of receiving, by the operating server, membership registrations of the treasure hunting service from the user terminals through an Internet; a treasure hiding step of storing, by the hider terminal, treasure hiding information in the operating server, the treasure hiding information including information of a specific treasure hunting event and location information of the treasure in the real environment; and a treasure hunting step of storing, by the hunter terminal, treasure hunting information in the operating server, the treasure hunting information including unique information identified by the treasure found in the real environment based on the treasure hiding information provided to the hunter terminal, wherein, the operating server may determine to give a corresponding treasure to the hunter terminal when a confirmation of the unique information is completed.

In order to achieve the above object, according to another embodiment of the present invention, there is provided a system for providing a treasure hunting service operated by an operating server and whereby a player finds a treasure hidden in a real environment with a virtual/real interaction, the system may include: user terminals including a hider terminal storing treasure hiding information in the operating server, the treasure hiding information including information of a specific treasure hunting event and location information of the treasure in the real environment, and a hunter terminal storing treasure hunting information in the operating server, the treasure hunting information including unique information identified by the treasure found in the real environment based on the treasure hiding information provided to the hunter terminal; an operating server receiving membership registrations and determining to give a corresponding treasure when a confirmation of the unique information being completed; and a database storing membership information and treasure hunting event information which are transmitted from the operating server.

### Advantageous Effects

A method for providing a treasure hunting service and a system therefor according to an embodiment of the present invention in which a virtual/real world interaction is performed by providing location information of the treasure and multi-stages for finding the treasure in a virtual environment and performing most of the stages in a real environment and leaving the screen. Interaction between the virtual and the real environments is constant since online activities lead to practical activities in the real environment and goal achievement. According to the interaction, there is an effect that mutual evaluations between game members, point acquisition, and grade promotion are constantly circulated.

Therefore, the on-line environment is overcome by constantly circulating the on-line environment and the real environment, a grade promotion is achieved by registering results obtained in the real environment to the virtual environment, and various qualifications and benefits are provided according to the grade promotion.

In other words, conventional game users rely on game programs made by game producers and obtain points, purchase items, or level promotions according to logics of the program, and their activities are performed by connecting through an Internet Cafe or their houses, or by playing smart-phones or other devices. However, game users of the present invention can play both roles of a hunter and a hider and freely plan and provide their own games with a virtual/real world interaction

### DESCRIPTION OF DRAWINGS

FIG. 1 is a block diagram of a system for providing a treasure hunting service according to an embodiment of the present invention.

FIG. 2 is a representative flowchart showing operational flow of the system for providing a treasure hunting service of FIG. 1.

FIG. 3 is a detailed flowchart of a treasure hunting step of FIG. 2.

FIG. 4 is a figure showing a screen provided in an evaluation step of the present invention.

FIG. 5 is a figure showing a screen in which treasure hunting information is displayed on a map that is applicable to the present invention.

### MODE FOR INVENTION

Reference will now be made in greater detail to an exemplary embodiment of the present invention, an example of which is illustrated in the accompanying drawings. Wherever possible, the same reference numerals will be used throughout the drawings and the description to refer to the same or like parts.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise. In addition, terms such as “ . . . unit”, “ . . . module”, or the like refer to units that perform at least one function or operation, and the units may be implemented as hardware or software or as a combination of hardware and software.

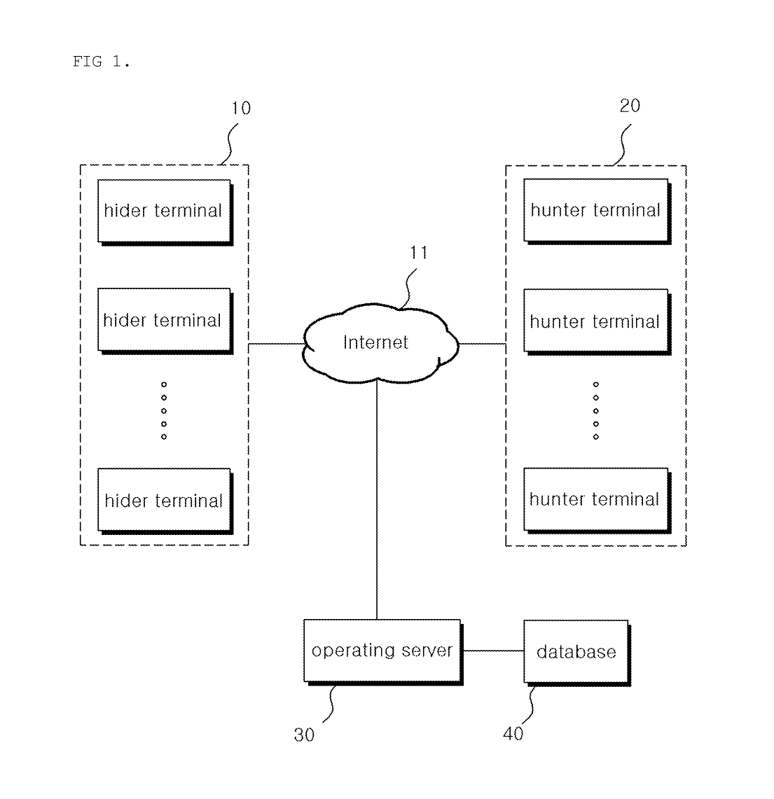

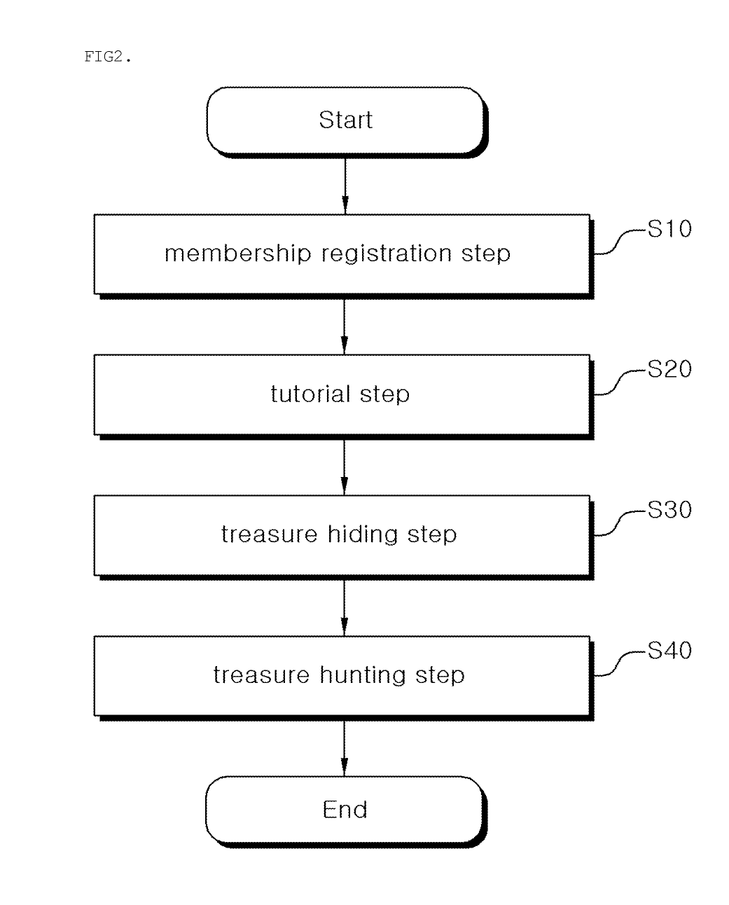

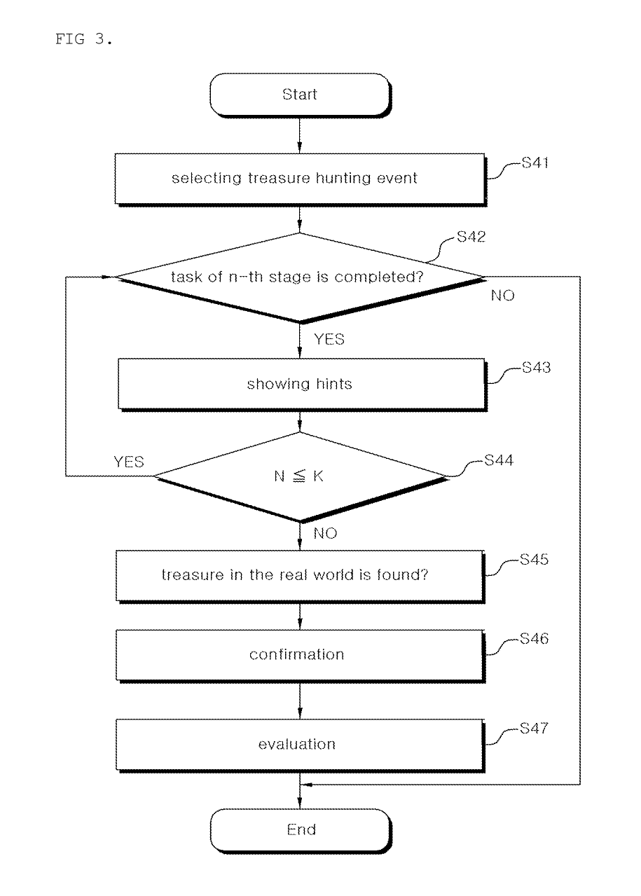

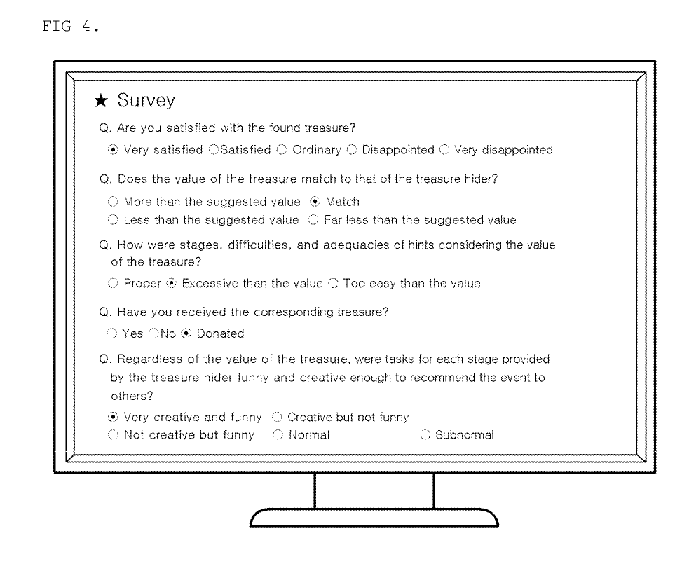

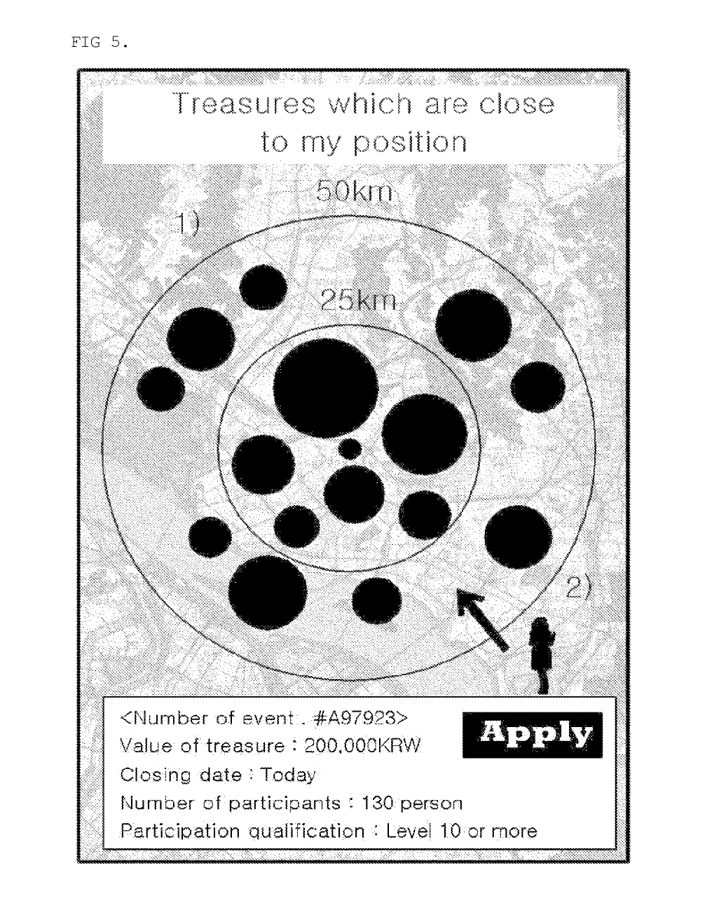

FIG. 1 is a block diagram of a system for providing a treasure hunting service according to an embodiment of the present invention, FIG. 2 is a representative flowchart showing operational flow of the system for providing a treasure hunting service of FIG. 1, FIG. 3 is a detailed flowchart of a treasure hunting step of FIG. 2, FIG. 4 is a figure showing a screen provided in an evaluation step of the present invention, and FIG. 5 is a figure showing a screen in which treasure hunting information is displayed on a map that is applicable to the present invention.

As shown in FIG. 1, a system for providing a treasure hunting service using wired and wireless communication of the present invention includes a hunter terminal 20 in which a user inputs and outputs various information to find the treasure, a hider terminal 10 in which a user inputs and outputs various of information to hide the treasure, an Internet 11 that is connected to both of the hunter terminal 20 and the hider terminal 10 to become a path of information, and an operating server 30 that is connected to the Internet 11 and provides various information to find the treasure.

The hunter terminal 20 and the hider terminal 10 include a multi-media function capable of receiving/transmitting text, image, voice, or video data. The user may access the operating server 30 through a web browser integrated in the user terminal 10 and receive the treasure hunting service by the Internet 11.

A computer accessible to the operating server 30 through the Internet 11 is used as the hunter terminal 20 and the hider terminal 10. In addition, a PDA or smart-phone capable of performing wireless data communication is also used as the hunter terminal 20 and the hider terminal 10.

In addition, all modern devices such as smart-phones including the Internet 11, mobile phones using a 2G or 3G network, and entertainment systems such as X-Box, Playstation, Nintendo Wii, etc. that are capable of transmitting data, are also used as the hunter terminal 20 and the hider terminal 10.

The Internet 11 is used as a data path in which the user is capable of transmitting an e-mail or file, searching information, and accessing information of hypertext, etc. through the user terminal 10.

The operating server 30 may perform membership registrations of users accessed through the hunter terminal 20 and the hider terminal 10, provide a treasure map, and perform a confirmation of the treasure. Also, the operating server 30 may provide various information related to the treasure map and perform an evaluation.

Also, the operating server 30 may include a database 40 which stores all sorts of information required for an operation of a game site, information of the treasure map, advertisement data information and membership information.

Meanwhile, when the user terminal including the hunter terminal 20 and the hider terminal 10 is located within an area in which a treasure hunting event is in progress, the operating server 30 may provide information of the treasure hunting event to the user terminal. In one embodiment, when the area in which the treasure hunting event is in progress is located in a tourist site, a building, a park, or a local government area, the operating server 30 may induce the user into participating as a hider or a hunter by announcing the treasure hunting event through a push notification.

Hereinafter, a method for providing a treasure hunting service is described with reference to FIG. 2.

Referring to FIG. 2, when the treasure hunting service is started, a user that plays a treasure hunter and user that plays a treasure hider perform a membership registration step (S10).

The membership registration step is the same as other website registrations in which an e-mail address and duplicated entry of a password are basically required. The user may set a nickname used within the game site, select a game character among the provided characters according to his preference, and change or decorate his character when a specific grade is achieved.

Except for the above information, reliable personal information such as name, sex, school name, job, position on his job, address, contact information, phone number, mobile phone number, additional e-mail address, credit card information or bank account information, etc. may be required.

Therefore, due to characteristics of a virtual/real world interaction, benefits that cannot be obtained through anonymous activities are guaranteed, and reliability of providing and finding treasure is achieved.

Game members may have restrictions on types of treasure hunting events that the game members can participate in and values of the treasure according to an accuracy of the registration information. This information is explained in the registration step.

When the membership registration is completed, if the game member wants, he or she may receive basic information of a treasure hunting event that is newly provided in an area of interest when the game member access the game site or according to a communication method that the game user selected during the registration step such as e-mail, mobile phone, Skype, Kakao Talk, Twitter, Facebook, etc. The game member may also receive treasure information related to the desired treasure types, difficulties of the treasure hunting event, grades having certain values, and levels of qualified treasure hunters. Treasure hunting event information that the game member can participate is also provided.

Present status of interested treasure hiders or treasure hunters, or activity information of guild members is provided to the game member.

Game members may share his or her treasure hunting results (value, difficulty level, grade, area, etc.) by using an SNS such as Twitter, Facebook, etc.

Personal information of the registered member is encoded and stored in the database 40 of the operating server 30.

Game members are divided into individual members and enterprise members. The individual member can play both a treasure hunter and a treasure hider, whereas the enterprise member may be a small/medium/large company that plays for profit. In addition, various agencies such as a University, museum, travel agency, tourism bureau, government branch, religious organization, entertainment agency, broadcasting company, newspaper company, etc., and the business partners of the above agencies can play the role of a treasure hider.

For the individual members the game is free of charge, but the game member can freely choose to be a paid member by paying a certain flat rate. The enterprise member may be a paid member according to a contract if the enterprise continuously provides treasure hunting events. However, although the treasure hunting events are irregularly provided, the enterprise member may also be a paid member according to a contract.

The game member who pays monthly flat rate through his or her bank account or credit cart may easily obtain a qualified member grade. This means that the qualified member has higher reliability than a free member. The paid member may participate in many treasure hunting events compared to the free member and the treasure values of treasures in paid member hunting events relatively higher than treasures available to free members.

Except for the individual member, a family, a guild affiliation with the individual and the family, a guild affiliation that is affiliation between guilds, etc. may participate in different treasure hunting events and different treasure values thereof according to the total number of paid members and total amount of paid monthly flat rate.

Provided information content, registration conditions, arrangement and adjustment of monthly flat rates, and various restrictions may be modified according to policies of a game operator.

When the membership registration is completed and the game member accesses the game site, the operating server 30 may provide an intro of promotional videos introductions of various treasure hunters to the user terminal. The game member may skip the videos if the game member has seen them before, or may select to watch then again through the menu.

Introduction videos may be modified and provided for individual members, family members, guild members, enterprises, etc.

Also, after gaining access, the game member may receive information such as hidden treasures, treasure quantity, a total value amount of the treasure, value of the found treasure, number of times that the treasure has been found, a guild situation, a membership situation, all of which are related to a region of the game user and throughout the world according to a preset, a choice, or a quest of the game user.

The game member may also receive information such as grades and levels of outstanding treasure hiders of regions and countries of the world, grades and levels of outstanding treasure hunters, a record and a rank of each guild, a treasure and a rank of the most valuable treasure at the present time, a treasure and a rank of the most valuable treasure of all time, a treasure hunting event with the greatest participants, a treasure hunting event in which the treasure is found the most times, etc., treasure hunting event information which is unsolved and is not closed by a treasure hider.

Also, the game member may also receive information of the most interesting treasure hunting event of major regions or the entire region and progress status information thereof.

The game member may receive detailed information of a treasure hunting event that is matched to the user according to the game member's choice or preset.

The game member may also receive information of his points and grades, points required for level promotion, reliability, current state of items, etc.

Contents, arrangements, and orders of the provided information may be modified according to policies of the game operator.

When the game member finishes the membership registration step, then a tutorial step is started (S20).

The tutorial step includes video tutorials by stage, guiding pictures, explanations, etc. and is provided to the game member by the game operator. The game member receives methods for playing as a treasure hunter and a treasure hider through the tutorial step and should essentially finish the tutorial step.

According to the tutorial step and additional examples, the treasure hider may be trained for providing method for suggesting various formats of tasks, basic quizzes, password suggestion methods, hint suggestion methods, etc. which are provided to the treasure hunter.

For the convenience of the game member, the operating server 30 provides several standardized methods and presetting such that the game member can easily perform the role of the treasure hider by just selecting several stages and inputs

After the tutorial step, the operating server 30 sends several warnings to the game member.

When the game member plays the treasure hider, the operating server 30 warns the game member that the treasure should be hidden in an open place, and the place should not be a place in which an excessive entrance fee, or a qualification or a security level is required. Also, the operating server 30 warns that the treasure should not be hidden in places such as battlefield or dangerous areas to access, or in unstable security areas.

Also, the operating server 30 warns that the treasure should not be hidden in places that require an excessive use of equipment or a structure change, or damage to a structure that can be recovered, and which causes economic loss. Warnings related such places may be added and changed by the game operator.

Any treasures hidden by the treasure hider may be definitely owned by the treasure hider. The treasure hider should not designate goods without he or she does own or treasure that is hidden in places without his or her control. In such cases, qualification of the membership may be restricted, stopped, or canceled by force by a single report of the treasure hunter. Treasure hiders with high reliability such as museums, schools, enterprises, government branches, local governments, tourist bureaus, etc. may hold the treasure hunting event having a prior consultation.

Also, the operating server 30 warns that grades and verification levels of the treasure hiders and the treasure hunters may be adjusted according to mutual evaluations between game users or reports of malicious members. Accordingly, chances and numbers of treasure hunting events that the game member can participate in may be increased or restricted, or the game member may be expelled by force.

The operating server 30 notifies that the treasure hunter should not present tasks including sexual discrimination or sexual harassment, or discriminations against race, job or the disabled.

The operating server 30 notifies that the treasure hunter who has finally found the treasure should perform a simple evaluation that may help to promote the grade of the treasure hunter. The evaluation includes evaluations of stages and difficulties of each state, adequacy of hints, etc.

The operating server 30 notifies that grades of treasure hunters and treasure hiders in which the accumulated evaluation is lower than a certain level may be unchanged or demoted. When an accumulated evaluation becomes higher, then, the verification level is also promoted, therefore, a grade promotion may be achieved.

The operating server 30 notifies that the satisfaction of given or found treasure should be selected from the suggested several levels. When the treasure hunting event is started, any communications or accesses between treasure hunters and treasure hiders is forbidden, and the operating server 30 notifies that the treasure hunting event has progressed according to stages and levels which are provided by the treasure hider before the game begins.

The operating server 30 notifies that a nickname of the treasure hider and a nickname of the treasure hunter may be replaced by separate codes. In other words, the operating server 30 assigns a temporary ID to a hunter terminal 20 and a hider terminal 10 such that the hunter terminal 20 and the hider terminal 10 cannot recognize each other. Also, information exchanges between the hunter terminal 20 and the hider terminal 10 are restricted or blocked. In such cases, the operating server 30 notifies that penalties such as membership restriction or disqualification which are determined by the game operator, may be enforced.

The operating server 30 notifies that qualifications of the treasure hunter may be an individual, a family, or a guild, or any qualification may be able to participate or is restricted to participate in the treasure hunting event according to the treasure hider and policies of the game operator. Also, when treasure hunters and treasure hiders who are reported several times and their memberships are canceled or restricted, or their grades are adjusted, the operating server 30 notifies the adjustment to the game members and gives them a chance to redeem themselves.

Although the game member is reported a single time, the game operator may immediately cancel the membership when the content of the report has a critical level.

Individuals may freely play both a treasure hunter and a treasure hider at no charge. However, the operating server 30 notifies that individual treasure hiders or enterprises that play for profits or promotions should pay a fee or pay for advertisement rates. The fee or rates is provided by the game operator or is determined in prior agreements.

The operating server 30 notifies that the treasure hider should take a legal responsibility and reliability of security related to operation of the treasure hunting event such as a verification of the treasure, a provision of the treasure to the treasure hunter who has found the treasure, a verification of the place in which the treasure is hidden, difficulties and hints for each stage, and answers thereof, etc.

When the value of the treasure that is finally found by the treasure hunter is significantly different or wrong than the value suggested by the treasure hider, the treasure hunter may evaluate and report it to the operating server 30. Then, the report may affect the grade and reliability of the treasure hider.

The operating server 30 notifies the treasure hunter that the more hints provided by the treasure hider, the lower grade will be obtained. However, use of items obtained by the treasure hunter such as hint-showing or stage-skipping is allowed within the minimum rage of each stage determined by the treasure hider, and the treasure hider cannot categorically refuse the use of these items.

The treasure hunter cannot share answers obtained by solving tasks provided by the treasure hider with other participants through the game site, a personal SNS, and a SMS message of mobile phone. The operating server 30 notifies that the treasure hunter who has committed these actions may receive penalties or disqualification from the treasure hunting event.

The operating server 30 notifies that the treasure hunter should take responsibility for himself for charges and time generated by participating in the treasure hunting event provided by the treasure hider, and cannot pass the responsibilities to the treasure hider and the game operator.

In addition, the operating server 30 notifies that the game member is responsible for a physical treasure that is exchanged personally between the treasure hunter and the treasure hider and without the operating server 30, or, a movement or transportation of the treasure through a physical distance, and, the operating server 30 notifies that the treasure should not naturally be decomposed, damaged, discolored, or deformed according to an elapsed time of the treasure hunting event.

Although it is not intended by the treasure hider, when the treasure hunter evaluates and reports the treasure hider that the treasure is damaged, lost, or absent due to the characteristic of the hidden place or the place being exposed to many and unspecified persons. Then, the treasure hider should prove his innocence for himself and, in case of necessity, the grade of the treasure hider may be adjusted.

The operating server 30 notifies that the treasure hider should not progress with the treasure hunting event with treasures having a social, moral or penal responsibility such as stolen goods, crime related goods, goods that are legally forbidden to distribute or possess, etc.

The operating server 30 notifies that a material or physical transportation of the treasure between the treasure hider and the treasure hunter may be canceled by mutual consent at the closing time of the treasure hunting event. In this case, the operating server 30 notifies that the cancelation does not affect reliabilities and evaluations of the both.

If necessary, the operating server 30 may additionally warn, add or modify notifications.

In addition, except for the notifications of registration step, agreement terms are provided in the registration step to avoid a legal prevarication.

When the treasure hunter does not find the treasure within a preset period determined by the treasure hider, the treasure hunting event may be closed and finished. Alternatively, the treasure hunting event may be extended according to the treasure hunter's choice, and this information is automatically notified to the treasure hunter and the treasure hider in time for the closing date.

Lastly, when a specific treasure hunter repeatedly obtains treasures of a specific treasure hider, the operating server 30 determines that there were unfairness between participants of the treasure hunting event and foul play such as an intentional treasure exposure, and a leakage of information. Then, the operating server 30 may perform a demotion of grades, a restriction of opportunity to participate, a membership suspension, a membership cancelation by force, etc. after an investigation.

When the operating server 30 finishes the above warnings and notifications, the game member performs the role of treasure hider.

In other words, when the game member selects the role of the treasure hider, then, a treasure hiding step is performed (S30).

The treasure hider may be individuals, families, guilds including plurality of individuals or families, enterprises for promotion or profits. In addition to the enterprise, museums or schools, various government offices, broadcasting companies, newspaper companies, entertainment management agencies, a tourist bureau, major tourist sites, local governments, etc may play the role of treasure hider.

Number of treasures, areas or countries in which the treasure hunting events are being simultaneous held, or a total limit value of treasures that can be provided by the treasure hider may be varied according to a grade and characteristics of the treasure hider.

The treasure hider suggests a detailed estimated value of the treasure. When the value of the treasure is an abstract value or an abstract value which is not connected to physical goods, the treasure hider should indicate this characteristic prior to starting of the game.

However, in spite of the abstract value, if the treasure hider provides a special reward to the treasure hunter, then the treasure hunter may skip the indication.

The treasure hider provides equal to or less than 20 stages to find the treasure, and such stages may be restricted according to a strategy of the treasure hider, the value of the treasure, and a grade of the treasure hider.

A task for each stage is provided by the treasure hider, the treasure hider may freely provide both virtual and real world tasks including tasks performed in the real word, getting on-line game points that can be verified, performing English studying, etc.

The treasure hider may set a difficulty for each stage, provide or not provide a hint, and one or more hints may be provided. Words with arithmetic characteristics, or background knowledge such as specific numbers, symbols, history or myths, math, physics, geography, astronomic information may be used as the hint.

In one embodiment, the hint for task of each stage of the treasure hider may be provided as following.

TABLE 1

| | |
|---|---|
| 1. Method for | 1) Task for first stage (Seoul, Geumcheon-gu): In |
| providing | the order of planets in the solar system, what |
| an address | number is earth from the sun? |
| by stage | 2) Task for second stage (Doksan 4-dong): How |
| | many satellites are orbiting the Earth? |
| | 3) Task for third stage (1024-8): How many |
| | satellites are in the solar system? |
| | 4) Task for fourth stage (detailed and specific |
| | place or angle of in which the treasure is |
| | hidden): What is the biggest planet in the solar |
| | system? |
| 2. Method for | 1) When passing first stage: 37N |
| providing | 2) When passing second stage: 126E |
| coordinates | 3) When passing third stage: 37.27N |
| by stage | 4) When passing fourth stage: 126.98E |
| | 5) When passing fifth stage: detailed and |
| | specific place or angle of in which the treasure |
| | is hidden |
| 3. Method for | 1) Task for first stage(First vertex 37.2N, |
| providing | 126.98E): Performing and getting 70 points or |
| coordinates | more in vocabulary or problem test of English |
| of vertex of | studying website |
| triangle, | 2) Task for second stage(Second vertex 37.02N, |
| pentagon, | 126.73E): Fourth item on the menu of Stark bucks |
| hexagon, | of Insa-dong |
| star, vertex | 3) Task for third stage(Third vertex 37.27N, |
| of cross | 126.52E): Number of green direction boards of |
| wire, or both | Posco intersection |
| end points of | 4) Task for four stage (center point of the |
| straight | above triangle, or center point or specific |
| line(triangle | distance point between two vertex): detailed and |
| is used for | specific place or angle of in which the treasure |
| the example) | is hidden |
| 4. Tasks | 1) Lifespan of the protected maidenhair tree |
| which are | located in OO park |
| solved by | 2) Management number of the nearest telephone |
| exploring the | pole of front gate of OO school |
| real | 3)Sign name located above OO Café of Posco |
| environment | intersection |
| | 4)Thing which is located 20 m due south from the |
| | flagpole at half-mask of OO school |
| | 5) Task that is solved by simultaneously |
| | inputting required information of the treasure |
| | hider in multiple places within a short time by |
| | the treasure hunters (proving cooperation |
| | ability, when the treasure hunters are a family |
| | or guilds) |
| | 6) Task in which the location is understood by |
| | drawing curve or straight line in fixed area |
| | using a ruler, a protractor and a string, or |
| | intersections between two or three circles, etc. |

The treasure hider may perform his role by providing hints which specifies the location of the treasure for each stage by using various methods as described above.

The treasure hider may notify the treasure hunter prior to participation of the treasure hunting event that the treasure hunter should prepare tools that are helpful to finding the treasure, for example, a ruler, a protractor, a compass, a map, an altimeter, a flashlight, a laser, etc

However, the treasure hider should notify in which stage the tools are required.

The treasure hider may preset the treasure hunting event period indefinitely or definitely, set a period for an event entry, and set a period for passing each stage.

Also, the treasure hider may set a reward for the treasure hunter that has not passed the final stage but has passed certain stages.

When the treasure hunter fails to pass the stage within the preset period, the treasure hider may extend the period only just for few times, or change or add hints. When the task is replaced, the grade of the treasure hider may be affected by the replacement.

Answers required by the treasure hider may be limited to a preset language or preset languages, or a language limited to certain region of the world.

The treasure hider may limit the treasure hunter who participates in the treasure hunting event to individuals, families, a guild, a sex, or an age, or may limit participation to children, adolescents, adults, or senior citizens according to characteristics of the treasure. Alternatively, the treasure hider may publicize the treasure hunting event such that various groups may participate in the treasure hunting event. The treasure hider may also limit the number of participants.

Also, the treasure hider may publicize the treasure hunting event to the treasure hunters of individuals, families, guilds that are more than a certain grade or are verified to a certain level. In case of enterprises, this may be changed according to a prior agreement and consultation.

The next stage is only provided to the treasure hunter that has passed the prior stage. The number of treasure hunters that has passed and has failed to pass, and a ratio thereof are provided and displayed. The treasure hunter who has passed the stage may evaluate a difficulty, and a grade of the treasure hunter may be moved up by sincerely performing the evaluation.

The treasure hider should release some information such as if the treasure is hidden with an encoded serial number, a QR code, or a barcode, or if the treasure is hidden in a public and safe place with a serial number, a QR code, a barcode, etc. and a mark, a symbol, a stamp, an additional printout, or a logo pattern of the treasure hider. Cases or boxes including a serial number, a QR code, or a barcode may be released or not, if needed.

When a security of the treasure hunting event is required, the treasure hider may provide the treasure hunting event and all stages thereof in advance, or may provide the next stage when the prior stage is completed.

The treasure hider may release a certain part of the location of the treasure according to his intention or a preset stage, the certain part may be a country, a region within the country, province, city, district, town, names of park, mountain, school, building, amusement park, church, temple, public area, metro, supermarket, or department store. However, the treasure hider should provide the exact location to the treasure hunter that has passed all the stages. Alternatively, when the treasure hunter passes all the stages, then the treasure hunter should be able to find the exact location in the real environment or on a map.

If any treasure hunter has passed all stages within the preset period, any treasure hunter has participated in the treasure hunting event and the treasure hunting event has not been progressed, or all of the treasure hunters have dropped out by difficulties and stages, then, the treasure hider may cancel the treasure hunting event. After that, the treasure hider may plan again the treasure hunting event, but number of canceled times may affect the grade of the treasure hider.

A serial number and a QR code, or a barcode assigned to each treasure according to the treasure hider and a value and characteristic of the treasure is not provided to the treasure hider. The treasure hider may previously set that confirmation of the serial number and the QR code, or the barcode finally found by the treasure hunter may be certified by inputting and registering the code to the game site or by accessing through an application. Such certification may be replaced by updating a picture, forwarding a mail, etc.

In one embodiment, the treasure is set by a treasure hider.

The treasure is set by transmitting a value of the treasure, a location of the treasure, a period of an event, a period for each stage, an entry period for participation before the first stage to the operating server 30.

When the treasure hider directly inputs a detailed value of the treasure, the operating server 30 may display the nearest one among the below values.

In other words, when 76,000 KRW (W) is input by the treasure hider, then the operating server may display 50,000 W˜100,000 W. or, the operating server may display 1) less than 5,000 W, 2) 10,000 W˜, 3) 50,000 W˜, 4) 100,000 W˜, 5) 500,000 W˜, 6) 1,000,000 W˜, 7) 2,000,000˜, 8) others to tens of millions or hundreds of millions W.

The location of the treasure may be filled out as following: Country ______ City/Province/Disctric ______ Town ______, or may be released in an address, if it's safe to say the address. A minimum location indication is essentially transmitted in cases such as mountain, river, street, park, temple, church, school, amusement park, additional specific place.

Total period of the treasure hunting event may be a specific period or a single day.

The period for each stage or total period of the treasure hunting event may be the same. According to the treasure hider's intention, the treasure hider may add a celebration of stage pass and give a gift to the treasure hunter having passed each stage to the treasure hunter having passed the stage.

Lastly, before starting the first stage, the entry period of the treasure hunting event may be entered in a date or a specific time.

When the above five piece of information are entered, a task setting process is followed. After the task setting process, a serial number and QR code, or a barcode is obtained, and the treasure hiding step is completed.

Also, as described above, the treasure hider may limit the treasure hunter according to a member qualification, a residence, a sex, an age, number of participants, a grade, a verification level and reliability, etc., and the treasure hider may specify background knowledge, tools, provided languages, etc.

Further, the treasure hider may select whether each stage is separately provided, a limit of item usage, a form in which the treasure being hidden, and an additional security factor.

The treasure hider may follow and discuss recommendations for security reasons when fairness is threatened by a participation of insider capable of accessing information related to the treasure hunting event or specific related person.

The treasure hider may access information of the treasure hunter who has finally found the treasure and has input and verified the treasure as a preset mode. The treasure hider may deliver a corresponding treasure through a shipment to a physical address, an e-mail, a SMS of mobile phone, a smart-phone application, etc. according to characteristics of the treasure. This information should be registered and confirmed in the game site.

When the treasure hunter receives the corresponding treasure, the treasure hunter should confirm the receipt by using his own accessing device such that the treasure hunter can continue to find the next treasure. When the treasure hunter fails to receive the corresponding treasure, the treasure hunter should inform the failure by using any ways and means to the operating server 30 and the treasure hider that has organized the treasure hunting event.

Personal information of the treasure hider and the treasure hunter may be limited according to a personal information protection policy and policies of the game operator.

The treasure hider should notify the game operator and a corresponding on-line page of the treasure hunting event when the treasure hunting event is impossible to progress due to a natural disaster, flood, damage, an unexpected reconfiguration or construction of a place in which the treasure being hidden that are generated during the treasure hunting event.

The treasure hider may not know how the treasure hunters have evaluated his event except for a single treasure hunter.

The treasure hider should notify event results to the game site when the treasure hunting event has finished, or this may automatically notified by the operating server 30.

The treasure hider may run an advertisement and public relations on the game site and members according to the agreement during the treasure hunting event.

The treasure hider may refuse to provide the corresponding treasure when the information of the treasure is incorrectly input or transmitted due to carelessness, mistake, or loss of the treasure hunter.

The treasure hider may provide tasks to the treasure hunter such that the treasure hunters may access the treasure, the tasks may be provided by using a physical address providing method in which a spatial area of the location of the treasure is gradually narrowed, a puzzle solving method in which the location information is obtained by solving all stages and gathering results thereof, a method in which a GPS coordinate (36.60N, 127.24E, etc) is obtained in a numeric form by stage, a method of using a map or an angle such as triangular coordinates or a center point of polygon, a method in which a problem itself includes an answer, an encoding method using different levels, or a method of obtaining and submitting certifications such as stamps by visiting several tourist sites.

The operating server 30 receives and stores information of the treasure hunting event from the treasure hider, and performs a comprehensive evaluation for the value and number of treasures, number of participants, and the event. After the evaluation, the operating server 30 assigns several points, useful items for the treasure hunter, or a participation qualification of the event, and finishes the treasure hiding step.

When the treasure hiding step of specific treasure hunting event is finished, the game member may participate and perform the treasure hunting step. The treasure hunting step is started through the participation of the game member (S40).

Herein, the game member may simultaneously participate in multiple treasure hunting steps and treasure hiding steps.

The treasure hunter may be individuals, families, guilds including plurality of individuals or families. The treasure hunter may be limited only to an individual, a family unit, a guild unit, or all units selected by the treasure hider. The all unit may include individuals, families, and guilds.

Detailed sequences of the treasure hunting step are described with reference to FIG. 3.

Referring to FIG. 3, when the game member selects to participate in the event (S41), a task of first stage is provided.

When the treasure hunter performs the first task (S42), then a hint provided by the treasure hider is released (S43).

The treasure hunter may specify the location of the treasure by using the hint, and try the next stage.

When the treasure hunter continuously completes tasks until the n-th stage, if n is equal to or less than k (k=20), then, the treasure hunter may specify the location of the treasure in close proximity by using hints provided by the treasure hider (S44).

Herein, when the treasure hunter completes the final stage, then the location of the treasure may be accurately specified and the treasure hunter may obtain the treasure in the real environment (S45).

The treasure hunter transmits codes identified through the treasure and performs a certification (S46).

When the certification is completed and the codes are verified to the treasure of the event, the operating server 30 determines to give a corresponding treasure to the treasure hunter (S47).

Then, the operating server 30 requests an evaluation of the treasure hunting event to the treasure hunter, and the treasure hunter performs the evaluation (S48).

The evaluation of the treasure hunting event may include tasks for each stage and difficulties thereof, and adequacy of hints. (Difficult, Appropriate, Easy, etc.)

In one embodiment, the evaluation of the treasure hunter may be performed as below and shown in FIG. 4.

TABLE 2

1. Are you satisfied with the found treasure? l)Very satisfied
2)Satisfied 3) Ordinary 4) Disappointed 5) Very disappointed
2. Does the value of the treasure match to that of the treasure
hider? 1)More than the suggested value 2) Match 3) Less than
the suggested value 4) Far less than the suggested value
3. How were stages, difficulties, and adequacies of hints
considering the value of the treasure? 1) Proper 2) Excessive
than the value 3) Too easy than the value
4. Have you received the corresponding treasure? 1) Yes 2)No
3)Donated
5. Regardless of the value of the treasure, were tasks for each
stage provided by the treasure hider funny and creative enough
to recommend the event to others? 1) Very creative and funny 2)
Creative but not funny 3) Not creative but funny 4) Normal 5)
Subnormal

The more the treasure hider obtains evaluations of creative and funny, the treasure hider may take a role of a freelancer who helps to establish stages and difficulties for a guild or an enterprise.

The more the treasure hider maintains his reliability by obtaining good evaluation from the treasure hunter, the more treasure hider may hold the treasure hunting events, or the treasure hider easily obtains opportunities to participate in treasure hunting events and items such as hint-showing or stage-skipping, or the treasure hider is capable of using more times of hint-showing and stage-skipping items when playing the role of treasure hunter. Also, chances to obtain items for other games are increased.

Stages and difficulties established by the treasure hider, who has set creative and funny stages and successfully finished his event, are posted on the “Hall of Fame” page. Thereafter, the treasure hider obtains items and more chances to participate in treasure hunting events having valuable treasure.

The treasure hunter should evaluate the treasure hunting event after obtaining the corresponding treasure such that the treasure hunter may continue to participate in the next treasure hunting event and maintain his reliability and grade.

The treasure hunting step of the treasure hunting event is ended when the evaluation is completed.

Herein, the treasure hider may limit the treasure hunter who participates in the treasure hunting event to a sex, an age, or may limit to children, adolescents, adults, or senior citizens according to characteristics of the treasure. Alternatively, the treasure hider may publicize the event such that various groups may participate in the treasure hunting event. The treasure hider may also limit number of total participants.

Also, the treasure hider may publicize the treasure hunting event to the treasure hunters of individuals, families, guilds that are more than a certain grade or are verified to a certain level.

The treasure hunter cannot ask any questions except for tasks, stages, or hints provided by the treasure hider, and cannot contact the treasure hider by using a separate communication medium. Furthermore, the treasure hunter takes the responsibility for penalties such as cancelations of grade and qualification, restrictions of participations, etc. which are caused by such behaviors.

When the treasure hunter drops out the treasure hunting event due to difficulties of tasks, lack of knowledge, etc., this may not affect the grade of the treasure hunter.

Answers obtained by solving tasks provided by the treasure hider during the treasure hunting event should not be shared to other participants through the game site, a personal SNS, a SMS message of mobile phone, etc., and the treasure hunter should be notified that the treasure hunter takes the responsibility of these behaviors, and receives penalties or is expelled from the event.

The more the treasure hunter requires hints provided by the treasure hider, the more achievement level of the treasure hunter may be affected.

Either or both information of the treasure hider and the treasure hunter is encoded according to characteristics or security requirements of the treasure hunting event, and the treasure hunter and the treasure hider may become known as temporary IDs during the event.

The treasure hunter who has finally found the treasure should evaluate the treasure hunting event such that the treasure hunter may continue to participate in the next treasure hunting event. The evaluation may affect the grade of the treasure hunter.

In other words, when the treasure hunter completes the evaluation of the treasure hunting event, grades of the treasure hunter and the treasure hider may be moved up or down. Accordingly, the treasure hunter and the treasure hider get benefits or restrictions for the treasure hunting event which is progressed or participated lately.

When the treasure hunter refuses to receive the corresponding treasure provided by the treasure hider, this may be officially confirmed in a page of the treasure hunting event and be also confirmed by the treasure hider.

The treasure hunter may donate the corresponding treasure according to the characteristic or value of the treasure after or before receiving the corresponding treasure through the game website, etc. The more the treasure hunter donates his treasure, the more the treasure hunter obtains points to move up higher grade. The points may be obtained by accumulating additional donation points, and the points may be used to purchase items or gifts. The donation points are publicized with the grade and reliability of the game member to other members through the game site.

The treasure hunter may automatically or manually publicize a result of the treasure found by himself, the value of the treasure, difficulties, grades, etc. through a SNS, etc.

When the treasure hunter finds serious problem or error in the task provided by the treasure hider, the treasure hunter should report the problem or the error to the game operator to fix it. However, when the report is caused by lack of knowledge, capacity, efforts, or mistake of the treasure hunter, the report is not fixed or modified.

If the treasure finally found by the treasure hunter has a social, moral or penal responsibility, such as stolen goods, crime related goods, goods that are legally forbidden to distribute or possess, etc., then, the treasure hunter should immediately report to the operating server 30 and, if necessary, report to the police.

Personal information of the treasure hider and the treasure hunter may be limited according to a personal information protection policy and policies of the game operator.

The treasure hider may not start the next treasure hunting event until the treasure hunter officially confirms the receipt of the corresponding treasure. However, the treasure hider may start the next treasure hunting event according to his grade, qualified level, whether or not being an enterprise.

The treasure hunter may post an epilogue or comments of the treasure, his own treasure hunting know-how, etc. in the game site. The game members may easily share and spread such postings by using an SNS, etc. and provide recommendations or opinions.

Thus, anyone may play the treasure hunter or the treasure hider whereby individuals, families, guilds, affiliation of guilds, etc. are included. Treasure hunting methods may include man to man, man to family, family to family, family to guild, man to guild, guild to guild, etc. A number of persons that are previously limited and shut off from the outside, or a number of persons that are invited and permitted may also play the treasure hunter. When the family and the guild, and the affiliation of the guilds play the treasure hunter, mutual communications between treasure hunters are possible.

A tournament method is also used as the treasure hunting method. The treasure hider may simultaneously hold national and international treasure hunting event. However, when the treasure hunting event is not an open event and is held internally in the game site, values and grades obtained in the event may be less than the publicized values and grades, and usage of items such as hints-showing/stage-skipping may be restricted or may be recommended.

The treasure hunter may obtain a hint-showing item and a stage-skipping item during the treasure hunting event for certain points, grades, or may be purchased in the game site.

The hint showing item shows the hint used to solve task to find the treasure regardless of a grade or points. The stage skipping item skips a difficult stage among multiple stages and is usable when the treasure hider allows to use it or according to the policies of the game operator.

The items are described in the following table.

TABLE 3

| Items | Characteristic |
|---|---|
| Hint | Items provided by the treasure hider that show related |
| showing | terms such as keywords, symbols, numbers, etc., |
| | expressions, or help that are useful to solve the task |
| | for each stage. The treasure hunter may purchase the |
| | item, or get a change to obtain the item when the |
| | treasure hunter completes the evaluation after finding |
| | the final treasure. The treasure hider or the game |
| | operator may limit number of uses of this item within |
| | single treasure hunting event. |
| Stage | The game operator allows use this item less than 20% |
| skipping | times of the total stages according to the stages and |
| | the difficulties since anyone may have lack of ability |
| | or difficulty to solve all the stages. The treasure |
| | hunter may use this item at least once when the |
| | treasure hider provides more than 5 stages. When 20 |
| | stages are provided, then the treasure hunter may use |
| | 2 to 4 times. However, this item is not usable in the |
| | final stage, and the key stage designated by the |
| | treasure hider. The treasure hunter may purchase the |
| | item, or get a chance to obtain the item when the |
| | treasure hunter completes the evaluation after finding |
| | the final treasure. The treasure hider may release |
| | information of the treasure by using stages or, the |
| | treasure hider may use the stages to reduce the number |
| | of treasure hunters. |
| Map | Map service is provided by various sites such as |
| | Google, Naver, Daum, etc. However, when a task for |
| | each stage provided by the treasure hider is to obtain |
| | coordinates of a straight line and polygons by |
| | tracking location on a map, then this item is used to |
| | input the corresponding coordinates and, shows various |
| | spatial coordinates such as center point of one side |
| | of the polygon, center of gravity, etc. The treasure |
| | hider may confirm the location of the treasure by |
| | adjusting the size and lengths of each side of the |
| | polygon in advance when establishing tasks for each |
| | stage. Then, the treasure hunter may track the |
| | coordinates established by the treasure hider by |
| | inputting the coordinates solved for himself. The |
| | treasure hunter may purchase the item, or get a chance |
| | to obtain the item when the treasure hunter completes |
| | the evaluation after finding the final treasure. This |
| | item shows a way to get the location, and arrival time |
| | for each transport by synchronizing nearby treasure |
| | and the treasure hunter's location. When the guild |
| | members approve to use location services, the members |
| | may solve tasks while confirming locations between |
| | themselves. A virtual ruler, compass, protractor, |
| | etc. are provided in the item. Major information is |
| | manually calculated by the treasure hunter and is |
| | display on the item. |
| See | The treasure hunter may purchase the item, or get a |
| through | chance to obtain the item when the treasure hunter |
| item | completes the evaluation after finding the final |
| | treasure. The treasure hider may hide the detailed |
| | information of the treasure by using various levels. |
| | The treasure hunter may know only publicized value of |
| | the treasure until the treasure hunter finds the |
| | treasure in the real environment himself. The |
| | treasure hider may gradually release information of |
| | the treasure when the stage is moved up to make the |
| | treasure hunter to find the treasure. The treasure |
| | hider may give the information from major category to |
| | minor category or, give a part of a picture, |
| | information that is speculative but difficult to guess |
| | the information. These methods are used for valuable |
| | treasure or, for causing curiosity marketing. This |
| | item shows more of the hidden information when the |
| | treasure hunter participates the treasure hunting |
| | event and passes the stages. This may arouse |
| | curiosity of the treasure hunter, so, the treasure |
| | hider should minutely plan the event. This item may |
| | be used as an additional reward program in which the |
| | treasure hunter identifies and matches what is the |
| | treasure. This is used for buzz marketing of wines, |
| | books, vehicles, designer clothes, fashion products, |
| | etc. The treasure hider may release information of |
| | the treasure for each stage or, the treasure hider may |
| | use the stages to reduce the number of treasure |
| | hunters. This item may be used to know such |
| | intentions of the treasure hider. |

Personal items, family items, guild items, guild affiliation items may be provided as the items. Such items may be items having special functions such as vehicle for private use for hunting treasure, a ship directed to the Treasure Island, a plane, various tools including fashions, magic, magnifying glasses, seeing through, etc.

Number of uses of such items may be limited according to a choice of the treasure hider and policies of the game operator. However, the game operator may allow unconditional usage of specific items in certain treasure hunting event according to the policies of the game operator.

Such items may be used as gifts or mutually sold or purchased between individuals, families, guilds, affiliations of guilds.

Productions, prices, sales policies of such items may be modified according to the policies of the game operator.

Meanwhile, as shown in FIG. 5, the location information of the treasure included in the treasure hunting information (treasure hiding information) and provided in the treasure hunting step may be displayed in a map which is provided by the operating server 30 to the hunter terminal 20 and, the location information of the treasure may be marked within various areas that are radially divided in a certain distance from the center location of the hunter terminal 20.

Accordingly, the treasure hunter who holds the hunter terminal 20 may easily know the treasure that is hidden nearby him and the distance from the treasure.

Also, the location information of the treasure may have different sizes that are proportional to the value of the treasure. In one embodiment, the location information of the treasure is displayed in circles, and the bigger circle means that the value of the treasure is larger. Thus, the treasure hunter may easily figure out the value of the treasure that the treasure hunter wants to find and, decide to which treasure to find considering its value.

In addition, the location information of the treasures may be marked with different colors according to a closing date of the treasure hunting event. In one embodiment, the treasure with a day of the closing date may be marked with red color, the treasure with 2-3 days left from the closing date may be marked with yellow color, and the treasure with 4 days or more left from the closing date may be marked with green. Thus, the treasure hunter may be actively induced to participate in the event having an imminent closing date.

Such a system for providing a treasure hunting service may be held by various organizations or groups such as persons who like to play a treasure hunting game, persons who want to spend time not only in a virtual environment but also in a real environment, persons who enjoy to play an intellectual game or tasks or, to find a treasure by using various tools and puzzles, families who want to enjoy games with not only a child or an adult but with all family members, enterprises that want to promote their products, schools that want to induce students not play an on-line games but to play games in the real environment whereby they can learn and research, travel agencies that want to offer various experiences and memories, entertainment management companies that want to raise awareness of entertainers and extend services to fans, broadcasting companies or newspaper companies that want to promote their major programs or to broadcast a present game, tourism bureaus, local governments, or tourist sites that desire tourist visitors, etc.

Such system for providing a treasure hunting service holds treasure hunting events not only in a virtual environment, but also in a real environment, thus, game members should physically move themselves. Therefore, various treasure hunting events are provided, kindergartens, elementary, middle, and high schools, and guilds or clubs of universities may participate in various treasure hunting events at home and abroad, game members may plan their own games and provide, compete, and obtain honors and treasures. The game operator may jointly hold treasure hunting events according to treasure hunter requests and agreements.

Travelers who are travelling or doing tours around the world, may be updated with information of various treasures, and the traveler may play the treasure hider or the treasure hunter during their travel or tours.

Individuals, families, guilds, and students and members of affiliations of guilds may solve tasks that require various knowledge and research provided by the treasure hider (individual, family, guild, affiliation of guild) by sharing and cooperating. Accordingly, friendship, knowledge, and experiences of the real environment may be accumulated by cooperating together.

In addition, a SNS such as Twitter, Facebook is used to boast the value of the treasure and share the result of the event. Further, the game member may be acknowledged for his ability through the SNS and induce various persons to participate in the treasure hunting event.

The above-described embodiment of the present invention is not embodied only by an apparatus and a method, but may be embodied by a program realizing functionality corresponding to the configuration of the embodiment of the present invention or a recording medium having the program recorded thereon. This may be easily performed by those skilled in the art from the above-described embodiment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for providing a treasure hunting service, the service using an operating server and user terminals including a hider terminal and a hunter terminal, whereby a player finds a treasure hidden in a real environment via a virtual/real world interaction, the method comprising:
a membership registration step of receiving, by the operating server, membership registrations of the treasure hunting service from the user terminals through an Internet;
a treasure hiding step of storing, by the hider terminal, treasure hiding information in the operating server, the treasure hiding information including information of a specific treasure hunting event and location information of the treasure in the real environment; and
a treasure hunting step of storing, by the hunter terminal, treasure hunting information in the operating server, the treasure hunting information including unique information identified by the treasure found in the real environment based on the treasure hiding information provided to the hunter terminal,
wherein, the operating server determines to give a corresponding treasure to the hunter terminal when a confirmation of the unique information is completed.

2. The method of claim 1, wherein the treasure hiding step includes a step of providing multi-stage tasks and a step of providing a hint when a task is executed, the hint being provided to each task, and being capable of specifying the location information of a treasure designated to the task.

3. The method of claim 1, wherein the treasure hiding information does not release location information of the treasure and the location information of the treasure is gradually released by executing the multi-stage task.

4. The method of claim 2, wherein the hint providing step provides the location information of the treasure by using a physical address providing method in which a spatial area of the location of the treasure is gradually narrowed, a puzzle solving method in which the location information is obtained by solving all stages and gathering results thereof, a method in which a GPS coordinate is obtained in a numeric form by stage, a method of using a map or an angle such as triangular coordinates or a center point of polygon, a method in which a problem itself includes an answer, an encoding method using different levels, or a method of obtaining and submitting certifications such as stamps by visiting several tourist sites.

5. The method of claim 1, wherein the treasure hiding information includes a detailed estimated value of the treasure.

6. The method of claim 2, wherein the treasure hunting step includes:
a step of providing task to each stage of a treasure hunting event;
a step of inputting the unique information of the treasure that is found in the real environment by using the hint of each stage, and
a step of performing the confirmation of the unique information of the treasure.

7. The method of claim 6, wherein the unique information is any one of a QR code, a barcode, or serial number, and is generated from the operating server and is not provided to the hunter terminal.

8. The method of claim 6, wherein the treasure hunting step further includes a step of evaluating the treasure hunting event after the confirmation.

9. The method of claim 1, wherein, after the membership registration step, the operating server provides at least one piece of information to the user terminals, the information including: information of hidden treasures, treasure quantity, total amount value of the treasure, value of the found treasure, number of times that the treasure has been found, a guild situation, and a member situation, all of which are related to a region of the user and throughout the world according to a preset, a choice, or a quest of the user;
information of grades and ranks of outstanding treasure hiders and outstanding treasure hunters of regions and countries of the world, a record and a rank of each guild, a treasure and a rank of the most valuable treasure at the present time, a treasure and a rank of the most valuable treasure of all time, a treasure hunting event with the greatest participants, and a treasure hunting event in which the highest number of treasures is found; and information of a treasure hunting event which is unsolved and is not closed by the treasure hider, so a user tries to participate in the event, the most interesting treasure hunting event of each region and progress status information thereof, and content information of treasure hunting events capable of being participated according to the user terminals.

10. The method of claim 1, wherein, at the treasure hunting step, multiple hunter terminals participate in the treasure hunting event as a group.

11. The method of claim 10, wherein the multiple hunter terminals are spatially separated and perform the treasure hunting step.

12. The method of claim 1, wherein the user terminals belong to any one of an individual, a guild, or a guild affiliation, and freely change and perform the treasure hiding step and the treasure hunting step.

13. The method of claim 1, wherein the operating server blocks an information exchange between the hunter terminal and the hider terminal, and performs:
a step of assigning, a temporary ID to the hunter terminal and the hider terminal to secure fairness of game progress, and
a step of blocking individual information exchange between the hunter terminal and the hider terminal.

14. The method of claim 1, wherein an item usage of the hunter terminal is allowed in the treasure hunting step, the item is a map item that is capable of tracking the location of the treasure on the map, and the location of the treasure is provided in the treasure hiding step.

15. The method of claim 1, wherein the location information of the treasure included in the treasure hunting information (treasure hiding information) and provided in the treasure hunting step, is marked on a map provided to the hunter terminal, and the location information of the treasure is marked within various areas that are radially divided in a certain distance from a center location of the hunter terminal.

16. The method of claim 15, wherein the location information of the treasure has different sizes which are proportional to the value of the treasure and has different color according to a closing date of the treasure hunting event.

17. A system for providing a treasure hunting service operated by an operating server whereby a player finds a treasure hidden in a real environment with a virtual/real world interaction, the system comprising:
user terminals including a hider terminal storing treasure hiding information in the operating server, the treasure hiding information including information of a specific treasure hunting event and location information of the treasure in the real environment, and a hunter terminal storing treasure hunting information in the operating server, the treasure hunting information including unique information identified by the treasure found in the real environment based on the treasure hiding information provided to the hunter terminal;
the operating server receiving membership registrations for the treasure hunting service through an Internet and determining to provide a corresponding treasure when a confirmation of the unique information is completed; and
a database storing membership information and treasure hunting event information which are transmitted from the operating server.

18. The system of claim 17, wherein the hider terminal provides multi-stage tasks and a hint for each task that specifies the location information of a treasure designated to the task when the task is executed, and the hunter terminal inputs the unique information of the treasure found in the real environment to perform the confirmation of the treasure, the unique information of the treasure being obtained by using the hint provided in each stage of a treasure hunting event.

19. The system of claim 17, wherein the operating server provides treasure hunting event information to the user terminal when the user terminal is located within an area in which the treasure hunting event is in progress.
